(19) United States
(12) Patent Application Publication
(10) Pub. No.: US 2010/0275815 A1
(43) Pub. Date: Nov. 4, 2010

(54) Anti-Reflective and Anti-Soiling Coatings with Self-Cleaning Properties

(76) Inventor: Bakul Champaklal Dave, Carbondale, IL (US)

Correspondence Address: OWENS TARABICHI LLP, 111 N. Market St., Suite 730, SAN JOSE, CA, 95113, US

(21) Appl. No.: 12/769,580

(22) Filed: Apr. 28, 2010

Related U.S. Application Data
(60) Provisional application No. 61/174,430, filed on Apr. 30, 2009.

(51) Int. Cl. C09D 5/00

(52) U.S. Cl. 106/287.1

(57) ABSTRACT

The embodiments of the invention are directed to organosilane-based coating compositions having anti-reflective, anti-soiling, and self-cleaning properties; methods of forming of the coatings; and articles of manufacture that utilize the coatings. In some embodiments, the coating compositions comprise an organosilane or mixture of organosilanes, a solvent, optionally an acid catalyst, and optionally a low molecular weight polymer.

### CROSS-REFERENCE TO RELATED APPLICATION

This application claims the benefit of U.S. Provisional Application No. 61/174,430 filed Apr. 30, 2009, the content of which is incorporated by reference herein in its entirety.

### BACKGROUND OF THE INVENTION

1. Field of the Invention

The embodiments of the invention are directed to organosilane-based coating compositions having anti-reflective, anti-soiling, and self-cleaning properties; methods of forming of the coatings; and articles of manufacture that utilize the coatings. In some embodiments, the coating compositions comprise an organosilane or mixture of organosilanes, a solvent, optionally an acid catalyst, and optionally a low molecular weight polymer.

2. Description of Related Art

Anti-reflective coatings are used in wide variety of commercial applications ranging from sunglasses, windows, car windshields, camera lenses, solar panels, and architectural systems. These coatings minimize the reflections on the surface of glass as the light rays travel through a discontinuous dielectric gradient. The reflection of light usually results in reduced transmittance of the light across the transparent material. For optical applications, it is important that a majority of incident light passes through the interface for maximum efficiency. In this context, anti-reflection coatings provide a useful benefit in optical applications.

Anti-reflective coatings are normally used in windows and glass panels associated with architectural and energy generating/saving systems. In building windows, they are used to maximize influx of incident light to maintain proper lighting or natural ambience as well as to minimize distracting reflections from building surfaces. In energy generating and saving devices, such solar panels and light collectors, the utility of anti-reflective coatings lies in the enhanced efficiency of these devices due to a greater degree of light transmittance and, therefore, increased energy generation for the same cost. In order for the anti-reflective coatings to perform their function, it is necessary that they be free from surface contamination and depositions (e.g., dirt) that may reduce light transmittance and, therefore, performance of the coatings.

For optical elements that are exposed to an outside environment, such as solar panels and building windows, the long term exposure to chemical and physical elements in the environment usually results in deposition of what is collectively known as “dirt” on the surface of the optical element. The dirt may comprise nanoparticles of sand, soil, soot, clay, geological mineral particulates, air-borne aerosols, naturally generated nanoparticles such as pollen, cellular debris, biological and plant-based particulate waste matter, and particulate condensates present in the air. Over the long term, such deposition significantly reduces the optical transparency of the optical element, such as glasses, acrylics, and other transparent materials that are utilized in transparent windows. Therefore, anti-reflective coatings deposited on such optical elements can lose their effectiveness when they get dirty. As a result, there is considerable expenditure of human and financial resources associated with regular cleaning of such optical elements, such as transparent windows and panels.

The deposition of dirt on such optical elements can be classified into two types—physically bound and chemically bound particulate matter. The physically bound particles are loosely held due to weak physical interactions such as physical entanglement, crevice entrapment, and entrapment of particulates with the nanoscale edges, steps, terraces, balconies, and boundaries on the uneven surface of the optical element, such as an uneven window surface. These particles can be dislodged with moderate energy forces such as wind, air from a mechanical blower, or by means of water flow induced by rain or other artificially generated sources of flowing water such as a water hose or sprayer. On the other hand, chemically bound particles are characterized by the presence of chemical interactions between the particles themselves and between the particulate matter and the optical element itself, such as glass or acrylics (e.g., plexiglass) used, for example, in windows. In these cases, removal of these particles becomes difficult and usually requires the use of physical means such as high pressure water hoses or manual scrubbing or both. Alternatively, chemical means such as the application of harsh solvents, surfactants, or detergents to the optical element to break free the dirt particles from the surfaces can be used.

As noted, the dirt on ambiently exposed optical elements, such as windows and panels, does get removed based upon natural cleaning phenomenon such as rainwater. However, rain water is only effective at removing loosely (physically) held particulate matter and is not able to remove the particulate matter that may be strongly (chemically) bonded to optical element, such as the glass or window surfaces. Furthermore, rain water usually contains dissolved matter that is absorbed from the environment during its descent that can leave an opaque film when dried. As such, all externally exposed optical elements, such as window materials, require some form of routine cleaning efforts associated with their maintenance regimen.

A majority of anti-reflective coatings are based on oxides as preferred materials. Some anti-reflective coatings are made of either a very porous oxide-based coating or, alternatively, are comprised of stacks of different oxides. These oxide materials are chemically reactive with dirt particles by means of hydrogen bonding, electrostatic, and/or covalent interactions depending upon the type of coating material and the dirt nanoparticle. Therefore, these oxide based coatings have a natural affinity to bind molecules on their surfaces. Further, highly porous coatings can physically trap dirt nanoparticles in their porous structure. Therefore, current anti-reflective coatings are characterized by an intrinsic affinity for physical and/or chemical interactions with dirt nanoparticles and other chemicals in the environment and suffer from severe disadvantages in maintaining a clean surface during their functional lifetime.

Therefore, it would be beneficial to provide anti-reflective coatings can be augmented to exhibit self-cleaning behavior that would keep them clean without the need for external human and/or mechanical intervention. It would be preferable to provide these benefits in the form of simple coatings that can reduce light reflection and scattering from the applicable optical surface while at the same time making the surface resistant to binding and adsorption of dirt particles (e.g., resistant to chemical and physical bonding of dirt particles).

It would also be preferable to enable deposition of such coatings onto the optical surface, such as the surface of a window or panel surface, using common techniques such as spin-coating; dip-coating; spray-coating; aerosol deposition; ultrasound, heat, or electrical deposition means; micro-deposition techniques such as ink-jet, spay-jet, xerography; or commercial printing techniques such as silk printing, dot matrix printing, etc. Further, it would be preferable for such coatings to be mechanically robust by exhibiting strength, abrasion resistance, and hardness sufficient to withstand the impact of physical objects in the environment such as sand, pebbles, leaves, branches, and other naturally occurring objects. It would be preferable for such coatings to also exhibit mechanical stability such that newly manufactured coatings or films would be less likely to develop cracks and scratches that limit their optimum performance, thereby allowing such coatings to be more effective for a relatively longer term of usage. In addition, it would be preferable for such coatings to be optically robust, thermally stable, chemically non interactive or inert with respect to gases and other molecules present in the environment, and un-reactive to light, water, acid, bases, and salts. In other words, the chemical structure of the surface of such coatings is an important factor in how the coating interacts with exogenous nanoparticles (e.g., dirt) and in determining the long term performance of the coatings.

Further, one of most common issue frequently associated with anti-reflective coatings is their performance over the entire solar spectrum. While there are several anti-reflective coatings that are only effective in a narrow region of the solar spectrum, for maximum efficiency it is desirable that the coatings perform equally well in the entire solar regions from 300-1100 nm.

### BRIEF SUMMARY OF THE INVENTION

The present invention provides anti-reflective coating compositions comprising an organosilane or mixtures of organosilanes, a solvent, optionally an acid catalyst, and optionally a low molecular weight polymer. In some embodiments, the invention provides a coating composition that comprises of an effective amount of organosilane or mixture of organosilanes and that provides a transparent surface with at least one of the following benefits: water and dirt resistance, anti-reflection, stability to UV light, surface inertness, reduced abrasion, scratching, and/or reduced absorption of light. The coating composition also comprises an effective amount of solvent that helps to dissolve and/or suspend the organosilane molecules, oligomers, and/or polymers. In some embodiments, the coating compositions are in a liquid form suitable for coating different substrates by means of suitable coating deposition method known in the art.

The invention also provides methods for applying the coatings of the present invention and for using such coatings. In some embodiments, the methods of treating a substrate comprise treating the surface with a coating composition made according to one embodiment of the present invention and slow curing the coating composition under ambient conditions or, alternatively, curing the composition by radiative, conductive, or convective heating under elevated temperature in an oven, over a heater, or under a incandescent thermal heat lamp or infrared heat lamp. In some embodiments, the methods for using the coatings of the present invention comprise use of the coating compositions to increase water resistance, oil/water repellence, anti-scattering, anti-reflection, abrasion resistance, UV stability, and to provide the benefits of anti-soiling and self-cleaning. In other embodiments, the invention provides for the use of the coating compositions as an efficiency enhancement aid in photovoltaic solar panel assemblies and in architectural windows in building and houses by the provision of anti-reflection benefits and/or by the provision of anti-soiling benefits to augment the anti-reflection benefits. In other embodiments, the invention provides for the use of the coating compositions as an efficiency enhancement aid in treatment of transparent surfaces (that require regular cleaning) to make them self-cleaning.

### BRIEF DESCRIPTION OF THE SEVERAL VIEWS OF THE DRAWINGS

FIG. 1 is a graph illustrating the anti-reflection behavior of a coated glass sample relative to an uncoated glass sample showing increased light transmittance for the coated sample according to one embodiment of the invention; and

FIG. 2 is a cross-sectional SEM showing the thickness of a coating according to one embodiment of the invention.

### DETAILED DESCRIPTION OF THE INVENTION

Various embodiments of the invention are described below in conjunction with the Figures; however, this description should not be viewed as limiting the scope of the present invention. Rather, it should be considered exemplary of various embodiments that fall within the scope of the present invention as defined by the claims. Further, it should also be appreciated that references to “the invention” or “the present invention” should not be construed as meaning that the description herein is directed to only one embodiment or that every embodiment must contain a given feature described in connection with the use of such phrases. In fact, various embodiments with common and differing features are described herein.

Generally, the present invention is based on use of non-porous, nonreactive coatings made from organosilanes that can provide the desired anti-reflective benefits and additionally characterized by having self-cleaning properties. In some embodiments, the organosilanes used in these coatings are physically and chemically nonreactive and are hydrophobic, oleophobic, water repellent, and self-cleaning. In some embodiments, the organosilanes adhere strongly to the surface of the substrate being coating, such as a glass surface, and form a mechanically strong coating that is anti-reflective, anti-soiling, abrasion-resistant, self-cleaning, and stable to UV light.

In some embodiments, the coatings made from organosilanes are characterized by an absence of porosity, and, therefore, they minimize the deposition of dirt by physical means. These coatings contain water and oil resistant hydro/fluoro-carbon groups that make them chemically non-reactive and non-interacting. The coatings bind to the glass surfaces using siloxane linkages that makes them adhere strongly to glass and also makes them strong, durable, and abrasion and scratch resistant. These coatings are characterized by a low energy surface that resists chemical and physical interactions and furthermore makes it easy to dislodge the particles thereby making the surfaces self-cleaning. The reduced physical and/or chemical interactions with the environment, such as dirt, make the exposed surface of these coating less susceptible to binding of dirt and also make it easier to clean with minimal expenditure of force or energy.

Generally, the present invention provides an anti-reflective coating composition comprising an organosilane or mixtures of organosilanes, a solvent, optionally an acid catalyst, and optionally a low molecular weight polymer. In some embodiments, the invention provides a coating composition that comprises of an effective amount of organosilane or mixture of organosilanes and that provides a transparent surface with at least one of the following benefits: water and dirt resistance, anti-reflection, stability to UV light, surface inertness, reduced abrasion, scratching, and/or reduced absorption of light. The coating composition also comprises an effective amount of solvent that helps to dissolve and/or suspend the organosilane molecules, oligomers, and/or polymers. In some embodiments, the coating compositions are in a liquid form suitable for coating different substrates by means of suitable coating deposition method known in the art.

The coating compositions of the present invention generally comprise organosilica monomers, oligomers, particles, polymers, and/or gels of organosilicate materials made from a single component or mixtures of starting materials having the general formula (X)ₙSi(R)₄₋ₙ and/or (X)ₙSi—(R)₄₋ₙ—Si(X)ₙ where X comprises halides, alkoxides, carboxylates, phosphates, sulfates, hydroxides, and/or oxides; n=1, 2, or 3; and R is an alkyl, alkenyl, alkynyl, phenyl, or benzenyl hydrocarbon and/or fluorocarbon chain with 1-20 carbon atoms and a solvent to dissolve or disperse the organosilane. Depending upon the application of the treatment composition, in some embodiments, the amount of organosilane or mixture of organosilanes can vary typically from about 0.1% to about 90%, from about 10% to about 65%, and from about 10% to about 25%, by weight of the coating composition. Examples of organosilanes that can be used include fluorosilanes including tridecafluoro-1,1,2,2-tetrahydrooctyl)triethoxysilane; tridecafluoro-1,1,2,2-tetrahydrooctyl)dimethylchlorosilane; 3,3,3-trifluoropropyl)trimethoxysilane; 3,3,3-trifluoropropyl)trichlorosilane; and 3,3,3-trifluoropropyl)methyldimethoxysilane; and organosilanes including methyltrichlorosilane, methyltrimethoxysilane, phenylmethyldiethoxysilane, dimethyldimethoxysilane, and n-propylmethyldichlorosilane. It should be appreciated that the foregoing fluorosilanes and organosilanes may be used alone or in any combination.

As noted, in some embodiments, the coating compositions comprise a solvent. In some embodiments, depending upon the application of the treatment composition, the amount of solvent can vary from 10% to about 99%, from about 35% to about 90%, and from about 75% to about 90%, by weight of the coating treatment composition. Non-limiting examples of useful solvents are generally alcohols and ketones. Specifically, more preferred solvents in some embodiments include acetone, ethanol, propanol, isopropanol, butanol, t-butanol, etc.

Optionally, the composition may contain other ingredients to provide additional benefits to improve performance, stability, and shelf life. For example, the coating composition may comprise, optionally, an acid catalyst. When an acid catalyst is used the coating composition may contain prehydrolyzed organosilanes that can be used for forming coatings. When an acid catalyst is used, the coating liquid becomes a viscous liquid that can used for making or applying the coating by rolling, screen printing, or by use of a brush or other mechanical implements of spreading the liquid evenly on the surface. In some embodiments, depending upon the application of the treatment composition, the amount of the catalyst can vary from 0.001% to about 2%, from about 0.1% to about 1%, and from about 0.01% to about 0.1%, by weight of the coating composition. Nonlimiting examples of useful catalysts are HCl, HNO₃, H₂SO₄, H₃PO₄, protonated amines such as N(H/R)₃₋ₙ[HX] where X comprises halides, nitrates, phosphates, or sulfates; n=0, 1, or 2; and R comprises an alkyl hydrocarbon chain, and combinations of the foregoing.

The coating compositions may also contain an optional low molecular weight polymer. The polymer functions as a binder for mechanical stability of the coatings. It also helps with the uniform spreading of the liquid for homogeneous coatings. In some embodiments, depending upon the application of the treatment composition, the amount of the polymer can vary from 0.1% to about 10%, from about 0.1% to about 1%, and from about 0.2% to about 0.5%, by weight of the coating composition. Examples of polymers that may be used include Poly (3,3,3-trifluoropropylmethylsiloxane), tridecafluorooctylmethylsiloxane, and dimethylsiloxane copolymer. It should be appreciated that combinations of these polymers may be used. It should be appreciated that combinations of polymers and acid catalysts may be used. Further, combinations of polymers may be used with combinations of acid catalysts.

Table 1 lists various coating compositions according to various embodiments of the present invention.

TABLE 1

| Fluorosilane | Organosilane | Solvent¹ | Acid | Polymer² |
|---|---|---|---|---|
| (vol. %) | (vol. %) | (vol. %) | (vol. %) | (vol. %) |
| (tridecafluoro-1,1,2,2- | | | | |
| tetrahydrooctyl)tri- | | | | |
| ethoxysilane (100%) | | | | |
| (tridecafluoro-1,1,2,2- | | | | |
| tetrahydrooctyl)di- | | | | |
| methylchlorosilane (100%) | | | | |
| (3,3,3-trifluoropropyl)tri- | | | | |
| methoxysilane (100%) | | | | |
| (3,3,3-trifluoropropyl)tri- | | | | |
| chlorosilane (100%) | | | | |
| (3,3,3- | | | | |
| trifluoropropyl)methyldi- | | | | |
| methoxysilane (100%) | | | | |
| | methyltrichlorosilane (100%) | | | |
| | methyltrimethoxysilane (100%) | | | |
| | Phenylmethyldiethoxysilane (100%) | | | |
| (tridecafluoro-1,1,2,2- | | I (50%) | | |
| tetrahydrooctyl)tri- | | | | |
| ethoxysilane (50%) | | | | |
| (tridecafluoro-1,1,2,2- | | I (50%) | | |
| tetrahydrooctyl)di- | | | | |
| methylchlorosilane (50%) | | | | |
| (3,3,3-trifluoropropyl)tri- | | I (50%) | | |
| methoxysilane (50%) | | | | |
| (3,3,3- | | I (50%) | | |
| trifluoropropyl)methyldi- | | | | |
| methoxysilane (50%) | | | | |
| (3,3,3-trifluoropropyl)tri- | | I (50%) | | |
| chlorosilane (50%) | | | | |
| | methyltrichlorosilane (50%) | I (50%) | | |
| | methyltrimethoxysilane (50%) | I (50%) | | |
| (tridecafluoro-1,1,2,2- | methyltrimethoxysilane | I (33%) | | |
| tetrahydrooctyl)tri- | (33%) | | | |
| ethoxysilane (33%) | | | | |
| (tridecafluoro-1,1,2,2- | dimethyldimethoxysilane | I (33%) | | |
| tetrahydrooctyl)tri- | (33%) | | | |
| ethoxysilane (33%) | | | | |
| (tridecafluoro-1,1,2,2- | n-propylmethyldichloro- | I (33%) | | |
| tetrahydrooctyl)tri- | silane (33%) | | | |
| ethoxysilane (33%) | | | | |
| (3,3,3- | methyltrimethoxysilane | I (33%) | | |
| trifluoropropyl)methyldi- | (33%) | | | |
| methoxysilane (33%) | | | | |
| (3,3,3-trifluoropropyl)tri- | methyltrimethoxysilane | I (33%) | | |
| methoxysilane (100%) | (33%) | | | |
| (tridecafluoro-1,1,2,2- | methyltrimethoxysilane | I (32%) | 0.04 m | |
| tetrahydrooctyl)tri- | (33%) | | HCl | |
| ethoxysilane (33%) | | | (1%) | |
| (3,3,3-trifluoropropyl)tri- | methyltrimethoxysilane | I (32%) | 0.04 m | |
| methoxysilane (33%) | (33%) | | HCl | |
| (1%) | | | | |
| (tridecafluoro-1,1,2,2- | dimethyldimethoxysilane | I (32%) | 0.04 m | |
| tetrahydrooctyl)tri- | (33%) | | HCl | |
| ethoxysilane (33%) | | | (1%) | |
| (tridecafluoro-1,1,2,2- | methyltrimethoxysilane | I (32%) | | A (1%) |
| tetrahydrooctyl)tri- | (33%) | | | |
| ethoxysilane (33%) | | | | |
| (tridecafluoro-1,1,2,2- | dimethyldimethoxysilane | I (32%) | | A (1%) |
| tetrahydrooctyl)tri- | (33%) | | | |
| ethoxysilane (33%) | | | | |
| (3,3,3-trifluoropropyl)tri- | methyltrimethoxysilane | I (32%) | | A (1%) |
| methoxysilane (33%) | (33%) | | | |
| (tridecafluoro-1,1,2,2- | dimethyldimethoxysilane | I (32%) | | B (1%) |
| tetrahydrooctyl)tri- | (33%) | | | |
| ethoxysilane (33%) | | | | |
| (tridecafluoro-1,1,2,2- | methyltrimethoxysilane | I (32%) | | B (1%) |
| tetrahydrooctyl)tri- | (33%) | | | |
| ethoxysilane (33%) | | | | |
| (3,3,3-trifluoropropyl)tri- | methyltrimethoxysilane | I (32%) | | B (1%) |
| methoxysilane (33%) | (33%) | | | |

¹“I” is Isopropanol
²“A” is poly(3,3,3-trifluoropropylmethylsiloxane); “B” is a copolymer of 15-20% tridecafluorooctylmethylsiloxane and 80-85% dimethylsiloxane

In some embodiments, the coating compositions are prepared by mixing the solvent, organosilane, the acid catalyst (if used), and the polymer (if used). The coating compositions of the present invention may be in the form of a stable liquid composition that can be independently applied to a given substrate, as a commercial formulation for use in a commercial coating process, or as pre-fabricated coating made from the composition for use as an article of commercial manufacture. The coating composition may be in the form of liquid, gel, lotion, paste, spray, or foam, preferably in the form of a liquid or viscous fluid, and more preferably in the form of a clear liquid. The composition is preferably applied to the substrates as a liquid, lotion, gel, or solution using a suitable method of forming a thin film or coating known in the art.

In some embodiments, the coating compositions are present as a clear liquid for use as a spray, or alternatively, as a dispersion, viscous liquid, or a mixture of these for use as a coating composition. In some embodiments, the coating compositions have a viscosity in the range of approximately 0.5-5 cP for clear liquid compositions and approximately 10-200 cP in the form of pre-hydrolyzed viscous liquid.

A substrate can be treated with the coatings of the present invention or the coating compositions or formulations can be applied to a substrate using known techniques in the art, such as spin-coating; dip-coating; spray-coating; aerosol deposition; ultrasound, heat, or electrical deposition means; micro-deposition techniques such as ink jet, spay-jet, xerography; or commercial printing techniques such as silk printing, dot matrix printing, etc. In some embodiments, after treating the surface with a coating composition made according to one embodiment of the present invention, the coating is slow cured or dried under ambient or room temperature conditions. Alternatively, the coating can be cured by radiative, conductive, or convective heating under elevated temperature in an oven, over a heater, or under an incandescent thermal heat lamp or infrared heat lamp a heater, oven or heat lamp can be used to accelerate the curing process.

The coating can be applied as a treatment for a given glass or other transparent substrate before or after it has been integrated into a device, such a solar cell, optical window or enclosure, for example, as part of a glass treatment process. Alternatively, it may be provided as a liquid composition, for example, for small scale treatment of glass in a treatment separate from their usage as windows in solar or architectural systems.

A particularly advantageous feature of the composition is that it does not require water as a specific component of the composition for the reaction or curing process to proceed. It is particularly advantageous that the coating compositions can be made to harden by reaction with moisture within the environment or alternatively by the trace amounts of water present in the solvent. The coatings compositions are, therefore, more stable for extended periods without exhibiting gelation.

The thickness of the coatings made can vary from 10 nm to 5 micron, from 100 nm to 1 micron, and from 100 nm to 500 nm. The contact angles of the coating can range from about 90 degrees to about 178 degrees, from about 110 degrees to about 155 degrees, and from about 125 degrees to about 175 degrees. The pencil hardness of the coating can vary from about 2H to about 9H, from about 4H to about 7H, and from about 6H to about 9H. The transmittance of a glass substrate coated with a coating composition made according to an embodiment of the present invention can vary from about 92% to about 100%, from about 93% to about 96%, and from about 95% to about 98%.

The invention also provides various methods for using the coatings of the present invention. In some embodiments, the invention provides for the use of the coating compositions to increase water resistance, oil/water repellence, anti-scattering, anti-reflection, abrasion resistance, UV stability, and to provide the benefits of anti-soiling and self-cleaning. In other embodiments, the invention provides for the use of the coating compositions as an efficiency enhancement aid in photovoltaic solar panel assemblies and in architectural windows in building and houses by the provision of anti-reflection benefits and/or by the provision of anti-soiling benefits to augment the anti-reflection benefits. In other embodiments, the invention provides for the use of the coating compositions as an efficiency enhancement aid in treatment of transparent surfaces (that require regular cleaning) to make them self-cleaning.

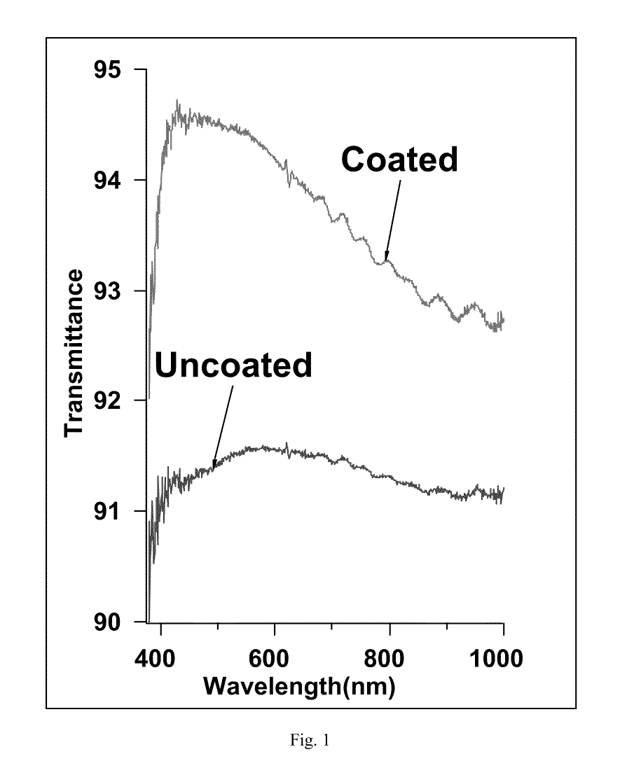

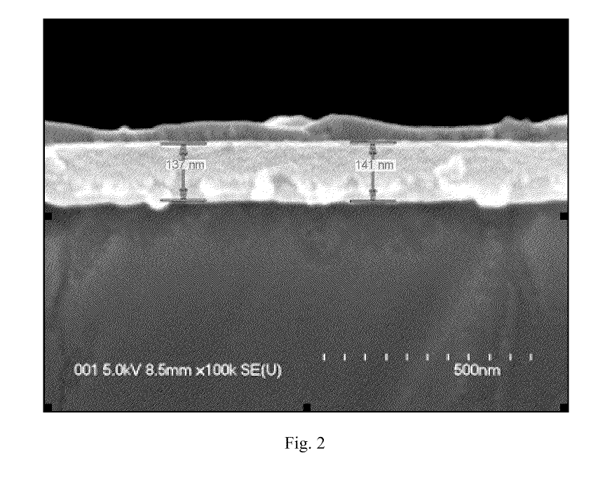

FIG. 1 is a graph illustrating the anti-reflection behavior of a coated glass sample relative to an uncoated glass sample according to one embodiment of the invention. FIG. 2 is a cross-sectional SEM showing the thickness of a coating according to one embodiment of the invention.

Various embodiments of the invention have been described above. However, it should be appreciated that alternative embodiments are possible and that the invention is not limited to the specific embodiments described above. Rather, the description of these embodiments should be considered exemplary of various embodiments that fall within the scope of the present invention as defined by the claims.

What is claimed is:

1. A composition, comprising:
an organosilane having a formula of (X)ₙSi(R)₄₋ₙ wherein X comprises halides, alkoxides, carboxylates, phosphates, sulfates, hydroxides, oxides or any combination of thereof; n=1, 2, or 3; and R comprises an alkyl, alkenyl, alkynyl, phenyl, benzenyl hydrocarbon, or fluorocarbon chain comprising 1-20 carbon atoms; and
a solvent.

2. A composition, comprising:
an organosilane having a formula of (X)ₙSi—(R)₄₋ₙ—Si(X)ₙ wherein X comprises halides, alkoxides, carboxylates, phosphates, sulfates, hydroxides, oxides or any combination of thereof; n=1, 2, or 3; and R comprises an alkyl, alkenyl, alkynyl, phenyl, benzenyl hydrocarbon, or fluorocarbon chain comprising 1-20 carbon atoms; and
a solvent.
